(19) United States
(12) Patent Application Publication
(10) Pub. No.: US 2015/0308624 A1
(43) Pub. Date: Oct. 29, 2015

(54) METHOD FOR REDUCING THE PRESSURE DROP ASSOCIATED WITH A FLUID SUBJECTED TO A TURBULENT FLOW

(71) Applicants: ENI S.P.A., Roma (IT); VERSALIS S.P.A., San Donato Milanese (IT)

(72) Inventors: Chiara Piseri, San Colombano al Lambro (IT); Lucilla Del Gaudio, San Donato Milanese (IT); Alessandro Casalini, Mantova (IT); Salvatore Coppola, Ravenna (IT); Davide Malinverno, Ravenna (IT); Romano Lima, Russi (IT)

(21) Appl. No.: 14/650,675

(22) PCT Filed: Dec. 23, 2013
(86) PCT No.: PCT/EP2013/077874

§ 371 Date: Jun. 9, 2015

(30) Foreign Application Priority Data
Dec. 28, 2012 (IT) MI2012A002248

(51) Int. Cl. F17D 1/17

(52) U.S. Cl. CPC F17D 1/17

(57) ABSTRACT

Method for reducing the pressure drop associated with a fluid subjected to a turbulent flow which comprises introducing at least one latex into said fluid, comprising: (a) a continuous aqueous phase; (b) a plurality of particles, dispersed in said continuous aqueous phase, of at least one branched (co) polymer having a branching degree {GR) ranging from 0.05 to 0.6, preferably from 0.08 to 0.5, and a weight average molecular weight (M_{w}) of the parent (co) polymer ranging from 100,000 Daltons to 700,000 Daltons, preferably ranging from 140,000 Daltons to 350,000 Daltons. Said method can be advantageously used in the case of a pressure drop in pipelines transporting liquid hydrocarbons such as, for example, petroleum, crude oils and refinery or petrochemical products, in particular for long distances.

The present invention relates to a method for reducing the pressure drop associated with a fluid subjected to a turbulent flow.

More specifically, the present invention relates to a method for reducing the pressure drop associated with a fluid subjected to a turbulent flow which comprises introducing at least one latex into said fluid, comprising: (a) a continuous aqueous phase; (b) a plurality of particles, dispersed in said continuous aqueous phase, of at least one branched (co)polymer having a branching degree (GR) ranging from 0.05 to 0.6, and a weight average molecular weight (M_{w}) of the parent (co)polymer ranging from 100,000 Daltons to 700,000 Daltons.

Said method can be advantageously used in the case of a pressure drop in pipelines transporting liquid hydrocarbons such as, for example, petroleum, crude oils and refinery or petrochemical products, in particular for long distances.

It is known that the main requirement for transporting a fluid through a pipeline is that the pressure at the pumping station must be such as to guarantee the required arrival pressure and fluid flow-rate.

It is also known that when fluids are transported through a pipeline, for example, in the case of the transportation of petroleum or of other liquid hydrocarbons, there is generally a pressure drop of the fluid which is due to friction between the internal wall of the pipeline and the fluid. As a result of said pressure drop, in order to obtain the desired flow-rate of the fluid at the arrival point of the pipeline, said fluid must be transported in the pipeline with a pressure which is sufficient for the purpose. As a result of structural limitations, however, it is not possible to operate at excessively high pressures.

The problems associated with pressure drops are more significant when the fluids are transported over long distances. Said pressure drops can cause inefficiencies which increase the costs with respect to both the equipments used for the purpose and also the functioning of the pipelines.

In order to overcome the above problems, the use of so-called drag reducers is known, i.e. compounds generally of a polymeric nature which, if dissolved in a fluid subjected to a turbulent flow, allow it to be moved in forced pipelines operating at lower pressure differentials with the same flow-rate of the fluid, or they allow the flow-rate of the fluid to be increased with the same pressure differential: in both types the unitary energy waste is therefore reduced.

American patent U.S. Pat. No. 7,888,407 describes a process for the preparation of a drag reducer which comprises: (a) consolidating a plurality of initial particles comprising at least one polymer prepared by emulsion polymerization so as to obtain one or more consolidated polymeric structures; (b) reducing the dimension of at least a part of said consolidated polymeric structures so as to obtain a plurality of modified polymeric particles; and (c) dispersing at least a part of said modified polymeric particles in a liquid carrier so as to obtain said drag reducer. The polymer prepared by emulsion polymerization can be in the form of a latex and can contain, for example, poly(2-ethylhexylmethacrylate) as active ingredient. Said drag reducer can be added to a fluid containing a hydrocarbon in order to reduce the pressure drop associated with the turbulent flow of the fluid containing a hydrocarbon through a pipeline.

American patent U.S. Pat. No. 7,884,144 describes a process comprising: (a) stirring a mixture in a substantially oxygen-free environment so as to obtain a stirred emulsion, wherein said mixture comprises: (i) water, (ii) one or more surfactants, (iii) a hydrate inhibitor, and a monomer; (b) polymerizing the monomer in the stirred emulsion in the presence of an initiator in order to generate free radicals and a catalyst, so as to obtain a drag reducer which at the same time also acts as hydrates inhibitor, in the form of latex. Said monomer is preferably an acrylate or methacrylate monomer.

American patent U.S. Pat. No. 8,022,118 describes a method which comprises introducing a drag-reducing polymer so that the pressure drop associated with the turbulent flow through the pipeline is reduced by suppression of the growth of turbulent vortexes, into a liquid hydrocarbon having an asphaltene content of at least 3% by weight and an API gravity index of about 26°, so as to obtain a liquid hydrocarbon having a viscosity not lower than that of the liquid hydrocarbon before the addition of the drag-reducing polymer; wherein the drag-reducing polymer has a Hildebrand solubility parameter which differs by less than 4 MPa^{1/2} from the Hildebrand solubility parameter of the liquid hydrocarbon; and the drag-reducing polymer is added to the liquid hydrocarbon in a quantity ranging from about 0.1 ppmw to about 500 ppmw. Said polymer can be a copolymer comprising repetitive units of residues of 2-ethylhexyl methacrylate monomers and butyl acrylate monomers, or it can be a homopolymer comprising repetitive units of residues of 2-ethylhexyl methacrylate monomers.

American patent U.S. Pat. No. 8,124,673 describes a polymeric solution as drag reducer having a viscosity lower than about 350 cP, measured with a shear rate of 250 sec⁻¹ and a temperature of 60° F. (15.5° C.), said polymeric solution being purified so as to obtain a content of solid particles NAS 1638 Class 12 or lower. Said polymeric solution, thanks to its low viscosity, can be easily sent through long and relatively small pipelines present in underwater umbilical lines without causing unacceptable pressure drops or blockages of the pipelines.

American patent U.S. Pat. No. 7,285,582 describes a modified drag reducer latex comprising: (a) a continuous phase; and (b) a plurality of particles of a high-molecular-weight polymer dispersed in said continuous phase, wherein said polymer particles have been formed by means of emulsion polymerization, said modified drag reducer latex having a hydrocarbon dissolution rate constant, in kerosene, at 20° C., of at least about 0.004 min⁻¹, said continuous phase comprising at least one surfactant having a high HLB (“hydrophylic-lipophilic balance”) (i.e. a HLB>8) and at least one surfactant having a low HLB (“hydrophylic-lipophilic balance”) (i.e. a HLB<6). Said hydrocarbon dissolution rate is obtained by the addition to the initial latex, obtained by means of emulsion polymerization, of at least one surfactant having a low HLB (“hydrophylic-lipophilic balance”) (i.e. a HLB<6) and/or of at least one solvent. Said modified latex can be used as drag reducer in order to reduce pressure drops resulting from the turbulent flow of a fluid through a pipeline.

American patent U.S. Pat. No. 7,763,671 describes a method for the preparation of a drag reducer comprising the following steps: (a) using emulsion polymerization for producing a first latex having a first hydrocarbon dissolution rate constant; and (b) modifying said first latex so as to obtain a second latex (i.e. a modified latex) having a second hydrocarbon dissolution rate constant; said first latex and said second latex being colloidal dispersions comprising particles of high-molecular-weight polymer in a continuous phase; said first hydrocarbon dissolution rate constant and said second hydrocarbon dissolution rate constant being measured, at 20° C., in kerosene; said second hydrocarbon dissolution rate constant being at least 10% higher than said first hydrocarbon dissolution rate constant; wherein at least one surfactant having a low HLB (“hydrophylic-lipophilic balance”) (i.e. a HLB<6) is added to said first latex. A solvent can also be added to said first latex. Said modified latex can be used as drag reducer in order to reduce pressure drops resulting from the turbulent flow of a fluid through a pipeline.

American patent U.S. Pat. No. 7,842,738 describes a composition capable of drag reducing comprising: (a) a continuous phase; (b) a plurality of first particles comprising a first drag-reducing polymer dispersed in said continuous phase, wherein said first particles have an average diameter ranging from about 25 μm to about 1500 μm, and (c) a plurality of second particles comprising a second drag-reducing polymer dispersed in said continuous phase, wherein said second particles have an average diameter lower than about 10 μm; wherein said composition has a total concentration of said first and of said second drag-reducing polymer of at least 35% by weight. Said drag-reducing composition can be added to a fluid containing hydrocarbons in order to reduce the pressure drop associated with the turbulent flow of said fluid through a pipeline.

Kulicke W. M. et al., in “Drag Reduction Phenomenon with Special Emphasis on Homogeneous Polymer Solutions” (1989), “Advances in Polymer Science”, Vol. 89, pages 1-68, describe homogeneous solutions of polymeric additives to be used as drag reducers. In particular, they point out that, in order to have a good drag reducer, it is necessary to: have a polymer with a high polymerization degree and a high chain flexibility; avoid branched polymeric structures in favour of linear polymeric structures; reduce the molecular weight of the monomeric units; and increase the coil volume, for example, by introducing side ionic groups, if the fluid is aqueous.

As indicated above, as problems associated with pressure drops in pipelines transporting liquid hydrocarbons such as, for example, petroleum, crude oils and refinery or petrochemical products, in particular for long distances, can cause inefficiencies which increase the costs with respect to both the equipments used for the purpose and also for the functioning of the pipelines, the study of new drag reducers is still of great interest.

The Applicant has therefore considered the problem of finding new drag reducers.

The Applicant has now found that latexes comprising (a) a continuous aqueous phase; b) a plurality of particles, dispersed in said continuous aqueous phase, of at least one branched (co)polymer having a branching degree (GR) ranging from 0.05 to 0.6, and a weight average molecular weight (M_{w}) of the parent (co)polymer ranging from 100,000 Daltons to 700,000 Daltons, are extremely efficient in reducing pressure drops associated with a turbulent fluid. In particular, the Applicant has found that, although in the presence of a branched (co)polymer, said latexes are extremely efficient in reducing pressure drops in pipelines transporting liquid hydrocarbons such as, for example, petroleum, crude oils and refinery or petrochemical products, in particular for long distances.

An object of the present invention therefore relates to a method for reducing the pressure drop associated with a fluid subjected to a turbulent flow which comprises introducing at least one latex into said fluid, comprising:
(a) a continuous aqueous phase;
(b) a plurality of particles, dispersed in said continuous aqueous phase, of at least one branched (co)polymer having a branching degree (GR) ranging from 0.05 to 0.6, preferably from 0.08 to 0.5, and a weight average molecular weight (M_{w}) of the parent (co)polymer ranging from 100,000 Daltons to 700,000 Daltons, preferably ranging from 140,000 Daltons to 350,000 Daltons.

Said branching degree (GR) was calculated according to the following equation:

(GR)=log₁₀ G′(0.1)−log₁₀ G′(0.01)

wherein:
G′ (0.1) is the elastic modulus expressed in Pa measured at an angular frequency (w) equal to 0.1 rad/s;
G′ (0.01) is the elastic modulus expressed in Pa measured at an angular frequency (w) equal to 0.01 rad/s.

Said elastic modulus G′ was measured on the dry branched (co)polymer, optionally containing an oil in a quantity ranging from 0 phr to 50 phr [phr=parts by weight of oil per 100 parts of dry branched (co)polymer], by means of Dynamic Mechanical Analysis (DMA) carried out at 90° C., according to the standard ASTM D4065-12.

For the aim of the present description and of the following claims, the term “parent (co)polymer” indicates the (co)polymer before branching.

The weight average molecular weight (M_{w}) of the parent (co)polymer was measured as described hereunder, with a sampling 3 hours after the start of the emulsion (co)polymerization described hereunder.

For the aim of the present description and of the following claims, the numerical ranges always comprise the extremes unless otherwise specified.

For the aim of the present description and of the following claims, the term “comprising” also includes the terms “which essentially consists of” or “which consists of”.

According to a preferred embodiment of the present invention, said fluid can be selected from petroleum crude oils, stabilized petroleum, other liquid hydrocarbons such as, for example, gas oils.

In order to avoid problems of freezing if said latex is used at low temperatures, i.e. temperatures lower than or equal to 0°, said continuous aqueous phase can comprise at least one antifreeze fluid.

According to a preferred embodiment of the present invention, said continuous aqueous phase can comprise at least one antifreeze fluid which can be selected, for example, from: glycols such as, for example, ethylene glycol, propylene glycol, glycerine; ethers such as, for example, ethyl ether, diglyme, polyglycols, glycol ethers. Said antifreeze fluid is more preferably selected from glycols, and is even more preferably ethylene glycol. Said antifreeze fluid is preferably present in said continuous aqueous phase in a such a quantity as to have a concentration of said antifreeze fluid in the latex ranging from 2% by weight to 20% by weight, more preferably ranging from 5% by weight to 15% by weight, with respect to the total weight of said latex.

According to a preferred embodiment of the present invention, said latex can have a viscosity, measured at 15° and at 300 s⁻¹, ranging from 30 mPa·s to 100 mPa·s, preferably ranging from 40 mPa·s to 70 mPa·s.

According to a preferred embodiment of the present invention, said latex can have a content of particles of branched (co)polymer (i.e. a total solid content), determined by means of the standard ISO 124:2011, ranging from 30% by weight to 70% by weight, preferably from 35% by weight to 65% by weight, with respect to the total weight of the latex.

According to a preferred embodiment of the present invention, said particles of branched (co)polymer can have an average diameter ranging from 50 nm to 600 nm, preferably ranging from 60 nm to 300 nm. The measurement of the average diameter of solid polymer particles was carried out by means of “Coulter Delsa Nano” dynamic light scattering after suitable dilution of the sample and by means of crossed analysis with CHDF200 (“Capillary Hydrodynamic Fractionation”) of Matec Applied Science.

According to a preferred embodiment of the present invention, said branched (co)polymer can comprise at least one oil in a quantity ranging from 0 phr to 50 phr [phr=parts by weight of oil per 100 parts of dry branched (co)polymer]. Said oil is preferably selected from oils having a flash point, measured according to the standard ASTM D93-12, higher than 65° C., preferably higher than 70° C., and a glass transition temperature (Tg) lower than −40° C., preferably lower than −50° C.

Oils that can be advantageously used for the purpose and which are commercially available are Lamix 30 and Lamix 60 of Eni SpA.

According to a preferred embodiment of the present invention, said latex can be present in said fluid in a quantity ranging from 0.1 ppmw to 500 ppmw, preferably ranging from 10 ppmw to 100 ppmw.

According to a preferred embodiment of the present invention, said branched (co)polymer can be a styrene-butadiene copolymer. Said styrene-butadiene copolymer preferably has a content of bound styrene ranging from 15% by weight to 40% by weight, preferably ranging from 20% by weight to 30% by weight, with respect to the total weight of the copolymer.

Said latex is preferably prepared by emulsion (co)polymerization.

Said emulsion (co)polymerization can be carried out starting from a reaction mixture comprising at least one monomer, a continuous aqueous phase, at least one anionic surfactant, and at least a system capable of generating free radicals. Said continuous aqueous phase generally comprises water and, optionally, at least one antifreeze fluid.

The latex used for the aim of the present invention is preferably prepared by the emulsion (co)polymerization of monomers selected from: styrene, 1,3-butadiene. Other unsaturated mono- and di-ethylene monomers can be optionally used in said emulsion (co)polymerization, in quantities lower than or equal to 10% by weight with respect to the total weight of the monomers present in the reaction mixture, such as, for example, acrylonitrile; α-β-unsaturated acids having the following formulae CH₂═C(R)—COOH wherein R═H, a C₁-C₄ alkyl group or CH₂COOH; acrylamide; vinyl acetate; isoprene; 2,3-dichloro-1-3 butadiene; 1-chloro-1,3-butadiene; vinyl chloride; C₁-C₄ alkylacrylate groups; C₁-C₄ alkylmethacrylate groups; divinylbenzene; vinylpyridine, N-methyl-N-vinylacetamide; N-vinylcaprolactam; N,N-isopropylacrylamide. Preferred monomers are: styrene, 1,3-butadiene, acrylonitrile, acrylic acid, methacrylic acid, acrylamide, butylacrylate, methylmethacrylate, 1-chloro-1,3-butadiene, divinyl benzene. Monomers even more preferred are: styrene, 1,3-butadiene.

Said anionic surfactant is preferably obtained by the saponification of fatty acids, having a linear structure and a number of carbon atoms higher than 14 and lower than 18, and a high HLB (“hydrophylic-lipophilic balance”), i.e. a HLB higher than or equal to 8, preferably higher than or equal to 10, more preferably higher than or equal to 12. Said anionic surfactant can be selected, for example, from: alkyl aryl sulfonates, alkyl sulfates, alkyl sulfonates, condensation products of formaldehyde with naphthene sulfonic acid, sodium and potassium salts of resinic acids, of oleic acid, or of fatty acids.

Anionic surfactants which can be advantageously used for the purpose and which are commercially available are the products of Undesa, Oleon, Huntsman, Basf.

Said system capable of generating free radicals is preferably selected, for example, from: inorganic peroxides such as, for example, salts soluble in water of peroxydisulfuric acid such as, for example, sodium salts, potassium salts, or ammonium salts; organic peroxides such as, for example, di-iso-propyl-benzene hydroperoxide, tert-butyl hydroperoxide, pinane hydroperoxide, paramenthane hydroperoxide; redox systems such as, for example, sodium peroxydisulfate/sodium dithionite, di-iso-propyl-benzene hydroperoxide/sodium formaldehyde sulfoxylate, redox systems using bivalent iron as reducing agent combined with auxiliary reducing agents (e.g., sodium formaldehyde sulfoxylate).

The water used for forming the reaction mixture is preferably purified water such as distilled or deionized water. As mentioned above, the continuous aqueous phase can comprise at least one antifreeze fluid selected from those indicated above.

The pH of the reaction mixture can be regulated by the addition of at least one mineral acid or of at least one organic acid, soluble in water and non-polymerizable such as, for example, acetic acid, citric acid, or mixtures thereof.

As already specified above, if the branched (co)polymer comprises at least one oil, the addition of said oil to the reaction mixture can be carried out together with the monomers before the start of the (co)polymerization.

Alternatively, the addition of said oil can be carried out by reprocessing the end-product (i.e. latex), also if oil has been partially added to the branched (co)polymer, without modifying the reaction mixture used in the emulsion (co)polymerization described above, operating at a temperature higher than 50° C., preferably ranging from 60° C. to 70° C., for a time longer than 30 minutes, preferably ranging from 1 hour to 4 hours.

In order to regulate the molecular weight of the (co)polymer, without significantly altering the (co)polymerization kinetics, said (co)polymerization can be carried out in the presence of at least one molecular-weight regulator. Preferably, said molecular-weight regulator can be selected, for example, from: dialkyl-xanthogen disulfides containing linear or branched C₄-C₂₀ alkyl groups such as, for example, methyl, ethyl, propyl, iso-propyl, butyl, hexyl, heptyl, octyl; alkyl mercaptans containing primary, secondary, tertiary, or branched C₄-C₂₀ alkyl groups, such as, for example, butyl, hexyl, octyl, dodecyl, tridecyl; or mixtures thereof. Said molecular-weight regulator is preferably an alkyl mercaptan containing C₄-C₂₀ alkyl groups, and is more preferably the product known as TDM supplied by Phillips Chevron or Arkema. The content of TDM preferably ranges from 0.01 phr to 0.5 phr, more preferably from 0.05 phr to 0.2 phr (phr=parts of TDM per 100 parts of monomers in the reaction mixture). When molecular-weight regulators selected from those indicated above are used, different from TDM, they are used in equivalent quantities with respect to those specified for TDM.

Said (co)polymerization is preferably carried out operating at a temperature ranging from 4° C. to 20° C., more preferably ranging from 10° C. to 18° C., in a substantially oxygen-free atmosphere, and at a pressure ranging from 0.35 bar to 6.9 bar, preferably ranging from 0.69 bar to 1.7 bar, more preferably at atmospheric pressure.

Said (co)polymerization can be carried out for a time sufficient for having a conversion of the monomers present in the reaction mixture ranging from 30% by weight to 100% by weight, preferably ranging from 50% by weight to 75% by weight, with respect to the total weight of the monomers present in the reaction mixture. Said (co)polymerization can generally be carried out for a time ranging from 1 hour to 10 hours, preferably ranging from 3 hours to 5 hours.

It should be pointed out that the quantity of molecular-weight regulator (in particular TDM), the (co)polymerization temperature and the conversion percentage, indicated above, allow a branched (co)polymer to be obtained, having the desired branching degree (GR) for the aim of the present invention.

Once the desired conversion of the monomers has been reached, the (co)polymerization can be interrupted by the addition of at least one (co)polymerization short-stopper such as, for example, phenothiazine, isopropylhydroxylamine, hydroxylamine sulfate, sodium tetrasulfide, sodium polysulfide mixed with monoisopropylhydroxylamine. The non-reacted residual monomers can be removed by stripping in a vapour stream in a continuous or batch column.

Said (co)polymerization can be carried out in continuous, batchwise or in semi-continuous.

Further details relating to the above (co)polymerization can be found, for example, in “High Polymer Latices” (1966), D. C. Blackley, Vol. 1, page 261, “Enciclopedia of Polymer Science and Technology”.

At the end of said (co)polymerization, the latex obtained is subjected to a concentration phase and, optionally, to an agglomeration phase and to a final concentration phase.

The latex obtained as described above, stored in cement tanks, is subjected to a concentration phase in order to increase the initial content of (co)polymer particles from 29% by weight-30% by weight, with respect to the total weight of the latex, up to 35% by weight, preferably up to up to 38% by weight, more preferably up to 40% by weight, with respect to the total weight of the latex. For this purpose, the latex is sent to an evaporator under vacuum. Before reaching said evaporator, the latex is heated to 50° C., preferably to 65° C., more preferably up to a maximum value of about 74° C., by passing it through a pair of heat exchangers positioned in series: the heating fluid is hot water at about 98° C.

At the inlet of the evaporator, there is a so-called “adiabatic flash” phenomenon, i.e. the vaporization of a small part of the water contained in the latex due to the heat supplied to the latex and low pressure present in the evaporator.

As already indicated above, at the end of said concentration phase, the latex can be optionally subjected to a controlled agglomeration phase of the particles and to a final concentration phase, before being restabilized for use.

The controlled agglomeration phase envisages a close gathering of the (co)polymer particles, a temporary interruption in the coating layer of ions and a consequent fusion into a particle having larger dimensions. This transformation causes a considerable decrease in the viscosity, due to the greater flowability of the large particles in water. Furthermore, the decrease in the overall surface of the (co)polymer particles causes an increase in the free anionic surfactant available, with a consequent increase in the stability of the latex.

The solid (co)polymer particles are in fact stabilized by the presence of a layer of anionic surfactant which coats them externally, composed of ions of the type R—COO⁻ which derive from the saponification of long-chain organic acids. These ions are therefore, in water, in equilibrium with the respective undissociated form of the corresponding acid:

R—COOH⇄R—COO⁻+H⁺.

The pH of the latex must therefore be partially neutralized and weakened to be able to facilitate said agglomeration phase without running into collapses of the latex and in order to facilitate a better dissolution of the latex obtained in the fluid (for example, petroleum), during the implementation of the method, object of the present invention. Said neutralization can be carried out by means of a careful and gradual reduction in the pH of the latex, which therefore facilitates a shift of the dissociation reaction of the acid indicated above (i.e. destabilization), towards the left. For this purpose, at least one mineral acid or at least one organic acid is used, soluble in water and non-polymerizable, such as, for example, acetic acid, citric acid, sodium fluoro-silicate, until a pH value of about 9 is reached, preferably 8.5, more preferably 8.2.

It should be noted that an excessive lowering of the pH could cause the formation of micro-clots in the latex due to an excessively strong destabilization.

After the addition of the acid, the agglomeration phase is then carried out with the use of alternative pumps, of the Malton Gaulin or Niro Soavi type, equipped with a particular lamination valve which, by subjecting the latex to high shear stress (preferably higher than 20 kPa, more preferably higher than 40 kPa), causes its agglomeration. The phenomenon can be more or less forced, depending on the shear stress to which the latex is subjected, which can be varied by activating the regulation present on the lamination valve.

The degree of agglomeration obtained can be evaluated by carrying out a turbidity analysis on the latex obtained, obtaining a value (Tb) which expresses the dimensions of the (co)polymer particles and the surface tension (Ts) of the same, said surface tension (Ts) indicating the quantity of anionic surfactant which is released from the interface of the (co)polymer particles: the more the value (Tb) increases, the more forced the agglomeration will be, the more the surface tension (Ts) increases, the blander the agglomeration will be. The value (Tb) and the surface tension (Ts) were determined according to the standard ASTM D1417-10.

The pH which was lowered in the agglomeration phase as described above, is then brought back to the desired value for the final application, preferably ranging from 8 to 12, by the addition, for example of potassium hydrate. It should be pointed out, however, that at the end of the agglomeration phase, the pH is generally higher than 8, due to the quantity of surfactant released in water during the agglomeration phase.

After the above pH adjustments have been completed, the latex obtained can be subjected to the final concentration phase, to bring the content of (co)polymer particles to a concentration ranging from 30% by weight to 70% by weight, more preferably ranging from 35% by weight to 65% by weight, with respect to the total weight of the latex, operating as described in the above said concentration phase, except for the fact that in this case two evaporators are used. In this case, before being sent to the two evaporators, the latex is heated to a maximum temperature of 80° C.-85° C. for the first evaporator, to a minimum of 50° C.-55° C. at the inlet of the second evaporator. Also in this case, there is a so-called “adiabatic flash” phenomenon as indicated above.

Alternatively, said final concentration phase can be carried out by means of cold cycles, i.e. after destabilization with weak acids of the latex, the latex can be subjected to the concentration phase by passage through cooling cycles: further details relating to said concentration phase can be found, for example, in Blacley D. C., “Polymer Lactices” (1997), Vol. 2, Cap. 10, sect. 10.4.2. Also in this case, the behaviour of the anionic surfactant in the agglomeration phase is the same as that indicated above.

The latex obtained as described above is used in the method object of the present invention as drag reducer.

As already specified, said method can be advantageously used in the case of pressure drops in pipelines transporting liquid hydrocarbons such as, for example, petroleum, crude oils and refinery or petrochemical products, in particular for long distances.

Some illustrative and non-limiting examples are provided hereunder for a better understanding of the present invention and for its embodiment.

### EXAMPLES

The characterization and analysis techniques indicated hereunder were used.

### Determination of the Weight Average Molecular Weight (M_{w})

The determination of the weight average molecular weight (M_{w}) of the (co)polymers obtained was carried out by means of GPC (“Gel Permeation Chromatography”) operating under the following conditions:

Agilent pump 1100;

I.R. Agilent 1100 detector;

PL Mixed-A columns;

solvent/eluent: tetrahydrofuran (THF);

flow: 1 ml/min;

temperature: 25° C.;

calculation of the molecular mass: Universal Calibration method.

### Determination of the Drag Reduction (DR)

The determination of the drag reduction (DR) was carried out by means of the method described hereunder.

The method consists in measuring the pressure drop connected with the turbulent flow of petroleum to which the drag reducer has been added inside a capillary tube.

For this purpose, the petroleum containing the drag reducer to be examined was inserted in a recipient having a diameter larger by at least a factor 10, preferably larger by a factor 30, than the capillary tube.

The petroleum containing the drag reducer, after being suitably thermostat-regulated, is forced to pass through the capillary tube by means of a piston which moves at a controlled velocity up to a value higher than 10 mm/s and preferably higher than 30 mm/s: the volumetric flow-rate was determined from the velocity and the section of the piston.

The pressure drop was determined by measuring the pressure drop at the ends of the capillary tube, suitably adjusted for the limit relating to the variation in the kinetic and geodetic energy according to equations (2) and (3) indicated hereunder: said pressure drop was then used for calculating the friction factor and inserted in equation (1) indicated hereunder for evaluating the drag reduction (DR), calculated in correspondence with a Reynolds number greater than 2,500:

$$D R = \frac{( fs - fa )}{fs} \qquad ( 1 )$$

wherein:
DR: drag reduction;
fa: friction factor of the oil containing the additive per unit of length of the capillary tube;
fs: friction factor of the oil not containing the additive per unit of length of the capillary tube.

The friction factor (fs) is linked to the pressure drop by means of the following equation (2):

$$f s = \frac{Δ E}{2 {v}_{2}^{2}} \frac{D}{L} \qquad ( 2 )$$

wherein:
ΔE: pressure drop, i.e. decrease in the absolute mechanical energy value AE per unit of mass connected with the dissipations calculated through the following equation (3):

$$Δ E = \frac{{p}_{1} - {p}_{2}}{ρ} + \frac{1}{2} ( {v}_{1}^{2} - {v}_{2}^{2} ) + g ( {h}_{1} - {h}_{2} ) \qquad ( 3 )$$

in cui:
p₁: pressure upstream of the capillary tube;
p₂: pressure downstream of the capillary tube;
ρ: density of the fluid;
v₁: velocity in the section with a larger diameter upstream of the capillary tube;
v₂: velocity in the capillary tube;
g: gravity acceleration;
h₁: height immediately upstream of the capillary tube;
h₂: height immediately downstream of the capillary tube;
D: diameter of the capillary tube;
L: length of the capillary tube.

### Example 1

### Comparative

0.5 l of petroleum coming from the reservoir of Monte Alpi, Val D′Agri (Basilicata, Italy), having a viscosity of 3 cP at a temperature of 30° C., were introduced into a dynamic mixer having a volume of 1 l. The petroleum was kept under stirring, at 20° C., for 3 hours.

About 30 ml of petroleum were subsequently transferred to a recipient having a capacity of 12 mm in diameter, thermostat-regulated at 30° C.: after about 10 minutes, the petroleum was forced to pass through a capillary tube having a diameter equal to 0.3 mm, by means of a piston which moved at a controlled velocity at a value equal to 40 mm/s, (which for the fluid considered corresponds to operating at a Reynolds number equal to 5,100). The pressures upstream and downstream of the capillary tube were registered, in correspondence, and the difference between them was calculated, i.e. the pressure drop which is indicated in Table 1.

Said pressure drop represents the reference for determining the effectiveness of the latexes considered in the following examples.

### Example 2

### Invention

The same procedure was adopted as in Example 1, except for the fact that 100 wppm of latex #1 was added to the petroleum, immediately after being introduced into the mixer, comprising a styrene-butadiene copolymer having a branching degree (GR) of 0.189 and a weight molecular weight (M_{w}) of the parent copolymer, measured with a sampling 3 hours after the start of the copolymerization described hereunder, of 148,000 Daltons.

The pressure drop and the drag reduction (DR) indicated in Table 1, were determined according to the equations (1), (2) and (3), indicated above.

The latex #1 was obtained by aqueous emulsion copolymerization of styrene and butadiene, according to the following process.

A jacketed stainless steel reactor, having a volume of about 7 litres, a diameter of 0.4 m, equipped with a mechanical stirrer with two turbine impellers having a diameter of 0.2 m, operating at 100 rpm, was pressurized with nitrogen at an initial pressure of 4 bar and thermostat-regulated by means of an oil circuit, circulating at a temperature of 15° C. The following products were subsequently fed to said reactor by means of transfer pumps:
600 g of an aqueous solution at pH 12 of oleic soap with a titer of 7.6%;
840 g of anhydrous butadiene and 360 g of styrene, previously mixed for 3 hours at a temperature of 0° C.;
0.66 g of TDM;
1.8 g of di-iso-propyl-benzene hydroperoxide;
100 g of an aqueous solution containing 1% of sodium formaldehyde sulfoxylate (SFS), 0.15% of ferrous sulfate, and 0.4% of ethylenediaminotetra-acetic acid (EDTA);
1700 ml of water.

The reaction mixture thus obtained was left to react, at 15° C., for 7 hours: after this period, 0.36 g of isopropylhydroxylamine (“short stopper”) were added. After 30 minutes, the non-reacted monomers were subjected to stripping by means of a stripper in a stream of vapour, at a pressure of 0.6 bar, for a period of 6 hours, with condensation and recovery of the non-reacted monomers and of the stripping water. During this operation, water is reintegrated in order to keep the fraction of copolymer, with respect to the same water, constant and equal to the reaction-end value.

### Example 3

### Invention

The same procedure was adopted as in Example 1, except for the fact that 100 wppm of latex #2 was added to the petroleum, immediately after being introduced into the mixer, comprising a styrene-butadiene copolymer having a branching degree (GR) of 0.143 and a weight molecular weight (M_{w}) of the parent copolymer, measured with a sampling 3 hours after the start of the copolymerization described hereunder, of 156,000 Daltons.

The pressure drop and the drag reduction (DR) indicated in Table 1, were determined according to the equations (1), (2) and (3), indicated above.

The latex #2 was obtained by aqueous emulsion copolymerization of styrene and butadiene, according to the following process.

A jacketed stainless steel reactor, having a volume of about 7 litres, a diameter of 0.4 m, equipped with a mechanical stirrer with two turbine impellers having a diameter of 0.2 m, operating at 100 rpm, was pressurized with nitrogen at an initial pressure of 4 bar and thermostat-regulated by means of an oil circuit, circulating at a temperature of 15° C. The following products were subsequently fed to said reactor by means of transfer pumps:
600 g of an aqueous solution at pH 12 of oleic soap with a titer of 7.6%;
840 g of anhydrous butadiene and 360 g of styrene, previously mixed for 3 hours at a temperature of 0° C.;
0.66 g of TDM;
1.8 g of di-iso-propyl-benzene hydroperoxide;
100 g of an aqueous solution containing 1% of sodium formaldehyde sulfoxylate (SFS), 0.15% of ferrous sulfate, and 0.4% of ethylenediaminotetra-acetic acid (EDTA);
1,700 ml of water.

The reaction mixture thus obtained was left to react, at 15° C., for 7.5 hours: after this period, 0.36 g of isopropylhydroxylamine (“short stopper”) were added. After 30 minutes, the non-reacted monomers were subjected to stripping by means of a stripper in a stream of vapour, at a pressure of 0.6 bar, for a period of 6 hours, with condensation and recovery of the non-reacted monomers and of the stripping water. During this operation, water is reintegrated in order to keep the fraction of copolymer, with respect to the same water, constant and equal to the reaction-end value.

### Example 4

### Invention

The same procedure was adopted as in Example 1, except for the fact that 100 wppm of latex #3 was added to the petroleum, immediately after being introduced into the mixer, comprising a styrene-butadiene copolymer having a branching degree (GR) of 0.115 and a weight molecular weight (M_{w}) of the parent copolymer, measured with a sampling 3 hours after the start of the copolymerization described hereunder, of 154,000 Daltons.

The pressure drop and the drag reduction (DR) indicated in Table 1 were determined according to the equations (1), (2) and (3), indicated above.

The latex #3 was obtained by aqueous emulsion copolymerization of styrene and butadiene, according to the following process.

A jacketed stainless steel reactor, having a volume of about 7 litres, a diameter of 0.4 m, equipped with a mechanical stirrer with two turbine impellers having a diameter of 0.2 m, operating at 100 rpm, was pressurized with nitrogen at an initial pressure of 4 bar and thermostat-regulated by means of an oil circuit, circulating at a temperature of 15° C. The following products were subsequently fed to said reactor by means of transfer pumps:
600 g of an aqueous solution at pH 12 of oleic soap with a titer of 7.6%;
840 g of anhydrous butadiene and 360 g of styrene, previously mixed for 3 hours at a temperature of 0° C.;
0.66 g of TDM;
1.8 g of di-iso-propyl-benzene hydroperoxide;
100 g of an aqueous solution containing 1% of sodium formaldehyde sulfoxylate (SFS), 0.15% of ferrous sulfate, and 0.4% of ethylenediaminotetra-acetic acid (EDTA);
1,700 ml of water.

The reaction mixture thus obtained was left to react, at 15° C., for 8 hours: after this period, 0.36 g of isopropylhydroxylamine (“short stopper”) were added. After 30 minutes, the non-reacted monomers were subjected to stripping by means of a stripper in a stream of vapour, at a pressure of 0.6 bar, for a period of 6 hours, with condensation and recovery of the non-reacted monomers and of the stripping water. During this operation, water is reintegrated in order to keep the fraction of copolymer, with respect to the same water, constant and equal to the reaction-end value.

### Example 5

### Comparative

The same procedure was adopted as in Example 1, except for the fact that 100 wppm of latex #4 was added to the petroleum, immediately after being introduced into the mixer, comprising a styrene-butadiene copolymer having a branching degree (GR) of 0.03 and a weight molecular weight (IL) of the parent copolymer, measured with a sampling 3 hours after the start of the copolymerization described hereunder, of 158,000 Daltons.

The pressure drop and the drag reduction (DR) indicated in Table 1 were determined according to the equations (1), (2) and (3), indicated above.

The latex #4 was obtained by aqueous emulsion copolymerization of styrene and butadiene, according to the following process.

A jacketed stainless steel reactor, having a volume of about 7 litres, a diameter of 0.4 m, equipped with a mechanical stirrer with two turbine impellers having a diameter of 0.2 m, operating at 100 rpm, was pressurized with nitrogen at an initial pressure of 4 bar and thermostat-regulated by means of an oil circuit, circulating at a temperature of 60° C. The following products were subsequently fed to said reactor by means of transfer pumps:
790 g of an aqueous solution of oleic soap with a titer of 7.6%;
83 g of anhydrous butadiene and 26 g of styrene, previously mixed for 3 hours at a temperature of −15° C.;
1.5 g of TDM;
4.2 g of sodium carbonate;
294 g of a solution of potassium persulfate with a titer of 3.6%;
720 ml of water;
   and the reaction mixture obtained was left to react, under the above conditions, for 1.5 hours.

272 g/h of the styrene-butadiene mixture obtained as described above was then fed, in continuous, to said reactor, by means of a dosage pump, for a period of 4 hours after which the mixture obtained was left to react for a further 2 hours.

After this period, the non-reacted monomers were subjected to stripping by means of a stripper in a stream of vapour, at a pressure of 0.6 bar, for a period of 6 hours, with condensation and recovery of the non-reacted monomers and of the stripping water. During this operation, water is reintegrated in order to keep the fraction of copolymer, with respect to the same water, constant.

### Example 6

### Comparative

The same procedure was adopted as in Example 1, except for the fact that 100 wppm of latex #5 was added to the petroleum, immediately after being introduced into the mixer, comprising a styrene-butadiene copolymer having a branching degree (GR) of 0.84 and a weight molecular weight (M_{w}) of the parent copolymer, measured with a sampling 3 hours after the start of the copolymerization described hereunder, of 152,000 Daltons. The pressure drop and the drag reduction (DR) indicated in Table 1 were determined according to the equations (1), (2) and (3), indicated above.

The latex #5 was obtained by aqueous emulsion copolymerization of styrene and butadiene, according to the following process.

A jacketed stainless steel reactor, having a volume of about 7 litres, a diameter of 0.4 m, equipped with a mechanical stirrer with two turbine impellers having diameter of 0.2 m, operating at 100 rpm, was pressurized with nitrogen at an initial pressure of 4 bar and thermostat-regulated by means of an oil circuit, circulating at a temperature of 9° C. The following products were subsequently fed to said reactor by means of transfer pumps:
600 g of an aqueous solution at pH 12 of oleic soap with a titer of 7.6%;
840 g of anhydrous butadiene and 360 g of styrene, previously mixed for 3 hours at a temperature of 0° C.;
0.66 g of TDM;
1.8 g of di-iso-propyl-benzene hydroperoxide;
100 g of an aqueous solution containing 1% of sodium formaldehyde sulfoxylate (SFS), 0.15% of ferrous sulfate, and 0.4% of ethylenediaminotetra-acetic acid (EDTA);
1,700 ml of water.

The reaction mixture thus obtained was left to react, at 9° C., for 5 hours: after this period, 1.5 g of isopropylhydroxylamine (“short stopper”) were added. After 30 minutes, the non-reacted monomers were subjected to stripping by means of a stripper in a stream of vapour, at a pressure of 0.6 bar, for a period of 6 hours, with condensation and recovery of the non-reacted monomers and of the stripping water. During this operation, water is reintegrated in order to keep the fraction of copolymer, with respect to the same water, constant and equal to the reaction-end value.

TABLE 1

| | Exam- | | Exam- | | Exam- | |
|---|---|---|---|---|---|---|
| | ple 1 | Example 2 | ple 3 | Example 4 | ple 5 | Example 6 |
| Pressure | 81 | 68.4 | 64 | 60 | 79 | 71 |
| drop | | | | | | |
| (bar) | | | | | | |
| DR | 0 | 15.6 | 21 | 26 | 3 | 12 |
| (%) | | | | | | |

From the data indicated in Table 1, it can be deduced that the latex used in Example 5 and the latex used in Example 6 comprising a branched (co)polymer having a branching degree (GR) outside the range described and claimed in the present invention, do not give the desired results: in particular, the latex of Example 5 and the latex of Example 6 give a lower drag reduction (DR) value with respect to the values obtained in Examples 2-4 according to the present invention.

1. A method for reducing the pressure drop associated with a fluid subjected to a turbulent flow which comprises introducing at least one latex into said fluid, comprising:
a) a continuous aqueous phase;
b) a plurality of particles, dispersed in said continuous aqueous phase, of at least one branched (co)polymer having a branching degree (GR) ranging from 0.05 to 0.6 and a weight average molecular weight (M_{w}) of the parent (co)polymer ranging from 100,000 Daltons to 700,000 Daltons.

2. The method for reducing the pressure drop associated with a fluid subjected to a turbulent flow according to claim 1, wherein said branched (co)polymer has a branching degree (GR) ranging from 0.08 to 0.5.

3. The method for reducing the pressure drop associated with a fluid subjected to a turbulent flow according to claim 1, wherein said branched (co)polymer has a weight average molecular weight (M_{w}) of the parent (co)polymer ranging from 140,000 Daltons to 350,000 Daltons.

4. The method for reducing the pressure drop associated with a fluid subjected to a turbulent flow according to claim 1, wherein said fluid is selected from petroleum crude oils, stabilized petroleum, and other liquid hydrocarbons.

5. The method for reducing the pressure drop associated with a fluid subjected to a turbulent flow according to claim 1, wherein said continuous aqueous phase comprises at least one antifreeze fluid selected from: ethylene glycol, propylene glycol, glycerine, ethyl ether, diglyme, polyglycols, and glycol ethers.

6. The method for reducing the pressure drop associated with a fluid subjected to a turbulent flow according to claim 5, wherein said antifreeze fluid is ethylene glycol.

7. The method for reducing the pressure drop associated with a fluid subjected to a turbulent flow according to claim 5, wherein said antifreeze fluid is present in said continuous aqueous phase in a such a quantity as to have a concentration of said antifreeze fluid in the latex ranging from 2% by weight to 20% by weight with respect to the total weight of said latex.

8. The method for reducing the pressure drop associated with a fluid subjected to a turbulent flow according to claim 1, wherein said latex has a viscosity, measured at 15° C. and at 300 s⁻¹ ranging from 30 mPa·s to 100 mPa·s.

9. The method for reducing the pressure drop associated with a fluid subjected to a turbulent flow according to claim 1, wherein said latex has a content of particles of branched (co)polymer, determined by means of the standard ISO 124:2011, ranging from 30% by weight to 70% by weight with respect to the total weight of the latex.

10. The method for reducing the pressure drop associated with a fluid subjected to a turbulent flow according to claim 1, wherein said particles of branched (co)polymer have an average diameter ranging from 50 nm to 600 nm.

11. The method for reducing the pressure drop associated with a fluid subjected to a turbulent flow according to claim 1, wherein said branched (co)polymer comprises at least one oil in a quantity ranging from 0 phr to 50 phr.

12. The method for reducing the pressure drop associated with a fluid subjected to a turbulent flow according to claim 11, wherein said oil is selected from oils having a flash point, measured according to the standard ASTM D93-12, higher than 65° C., and a glass transition temperature (Tg) lower than −40° C.

13. The method for reducing the pressure drop associated with a fluid subjected to a turbulent flow according to claim 1, wherein said latex is present in said fluid in a quantity ranging from 0.1 ppmw to 500 ppmw.

14. The method for reducing the pressure drop associated with a fluid subjected to a turbulent flow according to claim 1 any of the previous claims, wherein said branched (co)polymer is a styrene-butadiene copolymer.

15. The method for reducing the pressure drop associated with a fluid subjected to a turbulent flow according to claim 14, wherein said styrene-butadiene copolymer has a content of bound styrene ranging from 15% by weight to 40% by weight, with respect to the total weight of the copolymer.

16. The method for reducing the pressure drop associated with a fluid subjected to a turbulent flow according to claim 1, wherein said latex is prepared by the emulsion (co)polymerization of monomers selected from: styrene, 1,3-butadiene, optionally in the presence of other unsaturated mono- and di-ethylene monomers, in a quantity lower than or equal to 10% by weight with respect to the total weight of the monomers present in the reaction mixture; α-β-unsaturated acids having the following formulae CH₂═C(R)—COOH wherein R═H, a C₁-C₄ alkyl group or CH₂COOH; acrylamide; vinyl acetate; isoprene; 2,3-dichloro-1-3 butadiene; 1-chloro-1,3-butadiene; vinyl chloride; C₁-C₄ alkylacrylate groups; C₁-C₄ alkylmethacrylate groups; divinylbenzene; vinylpyridine, N-methyl-N-vinylacetamide; N-vinyl-caprolactam; N,N-isopropylacrylamide.

17. The method for reducing the pressure drop associated with a fluid subjected to a turbulent flow according to claim 16, wherein at the end of said (co)polymerization, the latex obtained is subjected to a concentration phase and, optionally, to an agglomeration phase and to a final concentration phase.
